(19) United States
(12) Patent Application Publication
(10) Pub. No.: US 2008/0126995 A1
(43) Pub. Date: May 29, 2008

(54) THREE DIMENSIONAL (3D) SEQUENCE DIAGRAM

(75) Inventors: Krzysztof R. Kobylinski, Toronto (CA); Eric Labadie, Toronto (CA)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/534,789

(22) Filed: Sep. 25, 2006

(51) Int. Cl. G06F 3/048; G06T 15/00

(52) U.S. Cl. 715/851; 345/419

(57) ABSTRACT

A computer program product providing an interactive three-dimensional (3D) sequence diagram calls for reading sequence data; and generating the 3D sequence diagram including a side view and a top view, the diagram depicting objects, methods and calls relating the objects and the methods; wherein the side view and the top view depict objects, methods and calls relating the objects and the methods that are hidden in a front view of the 3D sequence diagram; the 3D sequence diagram further including a scrolling feature for moving a side focus of the side view and a slicing feature for moving a top focus of the top view; wherein the slicing feature includes an adjustable height.

### TRADEMARKS

IBM® is a registered trademark of International Business Machines Corporation, Armor, N.Y., U.S.A. Other names used herein may be registered trademarks, trademarks or product names of International Business Machines Corporation or other companies.

### BACKGROUND OF THE INVENTION

1. Field of the Invention

The invention herein relates to presentation of data and more particularly to sequence diagrams.

2. Description of the Related Art

Present systems for presentation of sequenced data provide for uncertainty in interpretation of the data presented by a sequence diagram. There is no standard solution to the problem. There are some attempts to include the missing information in a standard sequence diagram but those do not solve the problem completely. Consider the following example.

In FIG. 1, a prior art sequence diagram 1 is provided. The sequence diagram 1 is two-dimensional (2D) and extends in an x-direction and a y-direction and provides a front view 11 (a 2D view). In the example of a sequence as depicted in FIG. 1, three objects are depicted. Each of object A 2, object B 3 and object C 4 include at least one method 5. Some of the methods 5 perform calls 6 to initiate other methods 5. In FIG. 1, relationships between three objects in the form of object method calls 6 are depicted. Object A 2 starts the sequence with two “messages to self” followed by a method call 6 to a method 5 of object B 3. The “messages to self” within the object A 2 indicate some interaction between methods 5 of the same object before object A 2 invokes a method 5 of the object B 3. Using the prior art sequence diagram 1 to represent this interaction, one can see that it is impossible to capture the precise details regarding the sequence of method calls 6 within object A 2. Additionally, it is impossible to tell which of the object A method calls 6 call object B 3. The same situation happens for object B 3. It can be seen that there is a method call 6 between two methods 5 of object B, but there is no way of telling which one of these two method calls 6 the method of object C 4.

In this example, at least two problems are noted. First, interactions within a single object are not clearly presented. Second of all, it is difficult or impossible to tell which methods 5, or components thereof, are performing calls 6 to other method objects or components.

Exemplary sequence data includes project data, software coding data (architectural design), logic data and analyses as well as any other data that includes sequences of data and information.

What is needed is a way to visualize information sequences having elements that are not clearly displayed in existing sequence diagrams. Preferably, the techniques for visualization provide for clear indications of communication paths, such as in the case where a method (component) of one object is calling method (component) of another object.

### SUMMARY OF THE INVENTION

The shortcomings of the prior art are overcome and additional advantages are provided through the provision of a computer program product stored on machine readable media and including machine readable instructions, for providing a three-dimensional (3D) sequence diagram, the instructions for: reading sequence data; and generating the 3D sequence diagram, the diagram depicting objects, methods and calls relating the objects and the methods.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution which data previously hidden in a 2D sequence diagram is revealed. The solution provides a computer program product stored on machine readable media and including machine readable instructions, for providing an interactive three-dimensional (3D) sequence diagram, the instructions for: reading sequence data; and generating the 3D sequence diagram including a side view and a top view, the diagram depicting objects, methods and calls relating the objects and the methods; wherein the side view and the top view depict objects, methods and calls relating the objects and the methods that are hidden in a front view of the 3D sequence diagram; the 3D sequence diagram further including a scrolling feature for moving a side focus of the side view and a slicing feature for moving a top focus of the top view; wherein the slicing feature includes an adjustable height.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a prior art sequence diagram that is two-dimensional;

FIG. 2 illustrates an exemplary embodiment of a computing infrastructure for practice of the teachings herein;

FIG. 3 illustrates one example of three-dimensional (3D) sequence diagram;

FIG. 4 illustrates one example of a 3D sequence diagram having scrolling columns;

FIG. 5 illustrates one example of a 3D sequence diagram enabled for adjusting a slice position to reveal content through a top view;

FIG. 6 illustrates one example of a 3D sequence diagram enabled for adjusting a height of the slice position to reveal content through the top view; and

FIG. 7 illustrates one example of a method for providing a 3D sequence diagram.

The detailed description explains the preferred embodiments of the invention, together with advantages and features, by way of example with reference to the drawings.

### DETAILED DESCRIPTION OF THE INVENTION

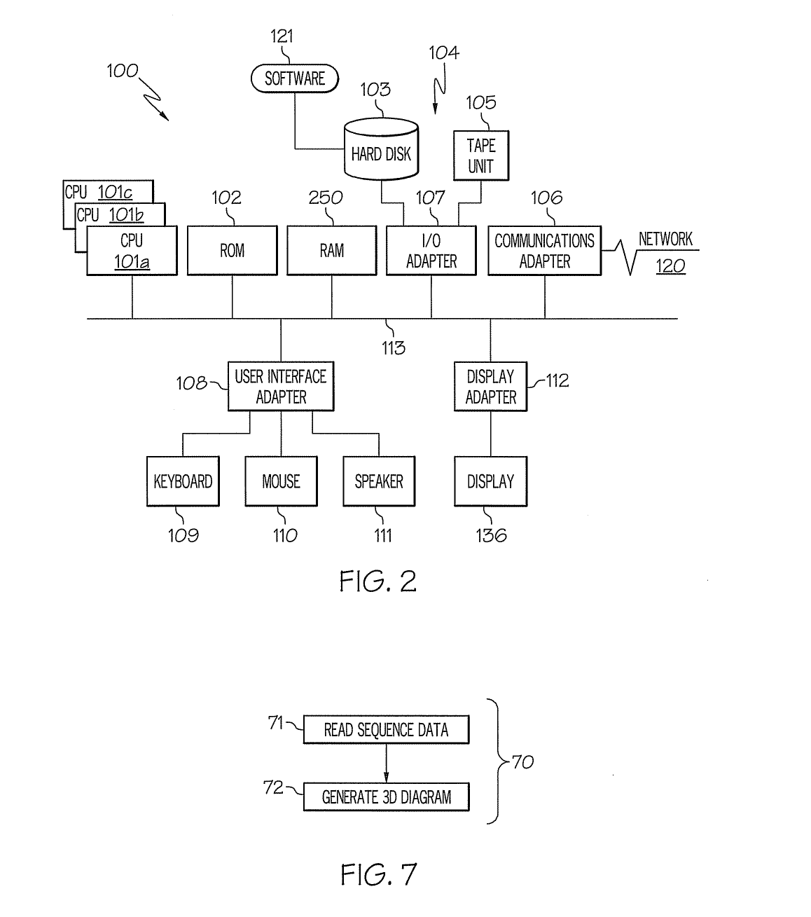

Referring now to FIG. 2, an embodiment of a processing system 100 according to the present invention is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 2 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 103) for providing a 3D sequence diagram 10. As disclosed herein, the instructions are referred to as 3D sequence diagramming software 121. The software 121 may be produced using software development tools as are known in the art.

Thus, as configured FIG. 2, the system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 2.

The teachings herein provide for extension of a prior art (i.e., two-dimensional (2D)) sequence diagram to a three-dimensional (3D) sequence diagram to enable visualization of all the interaction information which is not captured by the existing sequence diagram form. The teachings address situations where prior art sequence diagrams do not present all the vital information about method interactions within an object as well as interactions between objects.

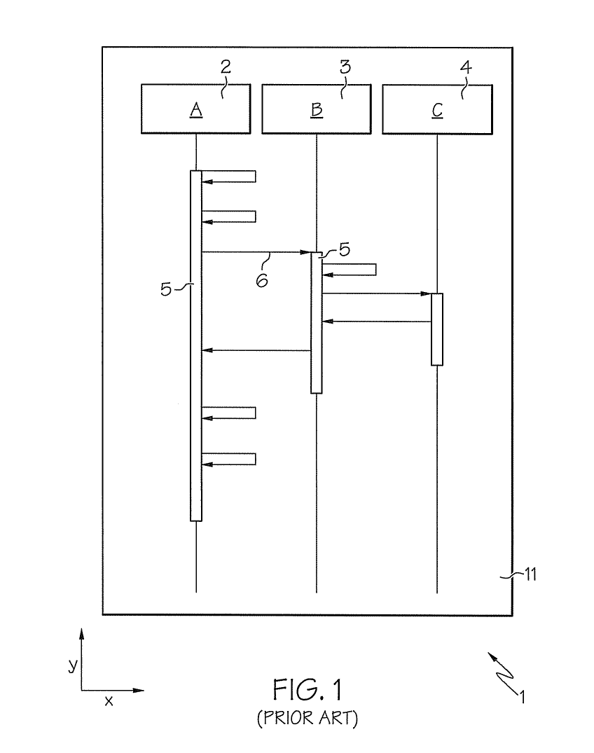

FIG. 3 depicts aspects of the sequence shown in FIG. 1. In FIG. 3, the sequence is shown in a 3D sequence diagram 10, extending in the x-direction, the y-direction and a z-direction. By adding a side view 12 (a second view) and a top view 13 (a third view) as two additional views of the sequence data, a better perspective of the sequence data is provided. For example, looking at the side view 12, all of the relationships for methods 5 of object A 2 may be seen.

The 3D sequence diagram 10 provides depictions that reveal what methods 5 are called and in what manner. For example, reference may be had to the top view 13 for information. The top view 13 indicates which methods 5 of object A 2 are invoked as well as which method 5 of object A 2 sends an outbound call 6 to a method 5 of object B 3.

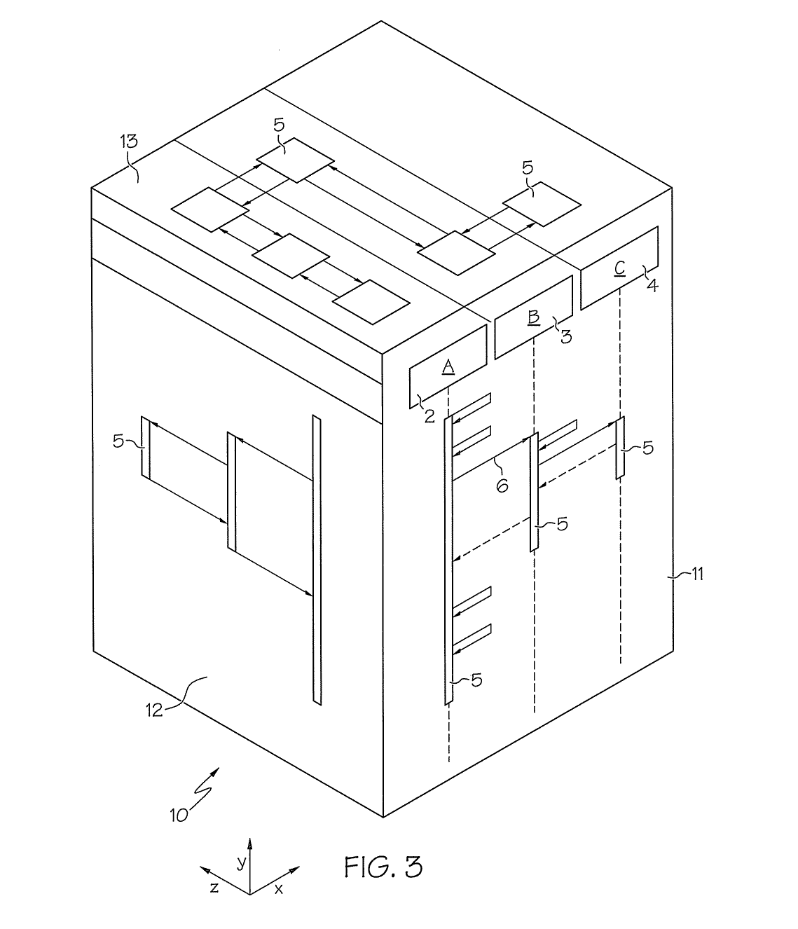

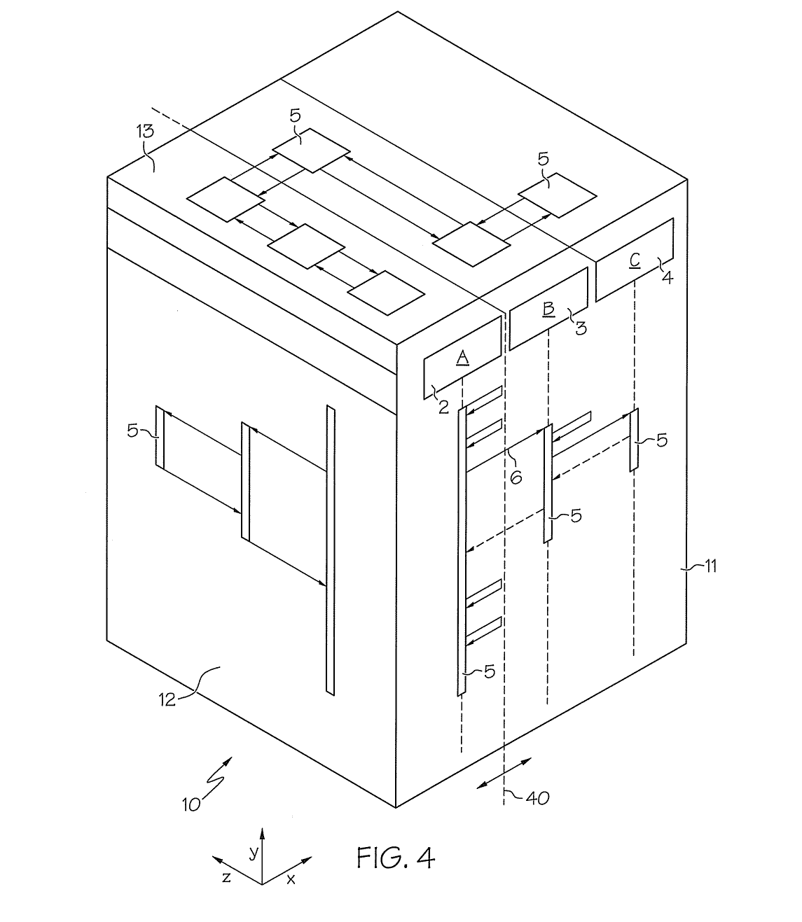

Embodiments of the 3D sequence diagram 10 provide for bringing any object to a side position (such as to the left), in order to view the previously hidden information. For example, in FIG. 4, a scrolling feature 40 provides for effectively moving a focus of the side view 12 from object A 2 to object B 3. This is depicted by the vertical dashed line in FIG. 4 (although it should be noted that the hidden portions of object B 3 are not revealed in FIG. 4).

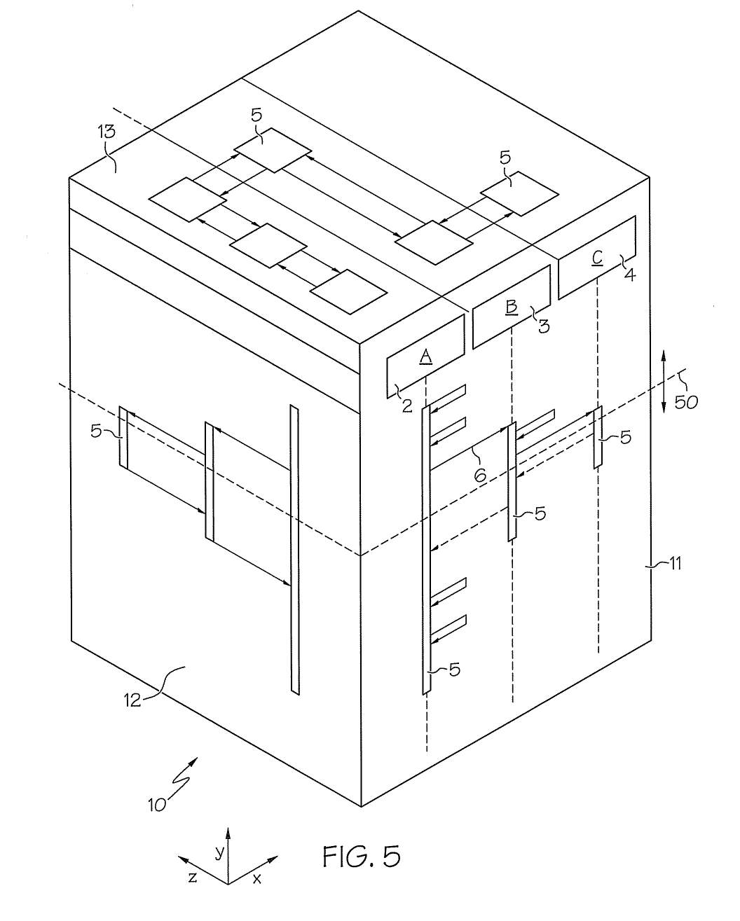

Similarly, the 3D sequence diagram 10 provide for bringing any object to the top position, in order to view the previously hidden information. For example, in FIG. 5, a slicing feature 50 provides for effectively moving a focus of the top view 13 from the top of the 3D sequence to a mid-portion thereof. This is depicted by the horizontal dashed line in FIG. 5 (it should be noted that hidden portions at the position of the slicing feature 50 are depicted in the top view 13).

In some further embodiments, the slicing feature 50 includes an adjustable height feature 60. Adjusting a slice position for the content of the top view enables selecting methods 5 and interactions (or calls 6) to be included in the top view. Only those methods 5 cut through by the slicing feature 50 (also referred to as a “slicer”) are presented in the top view.

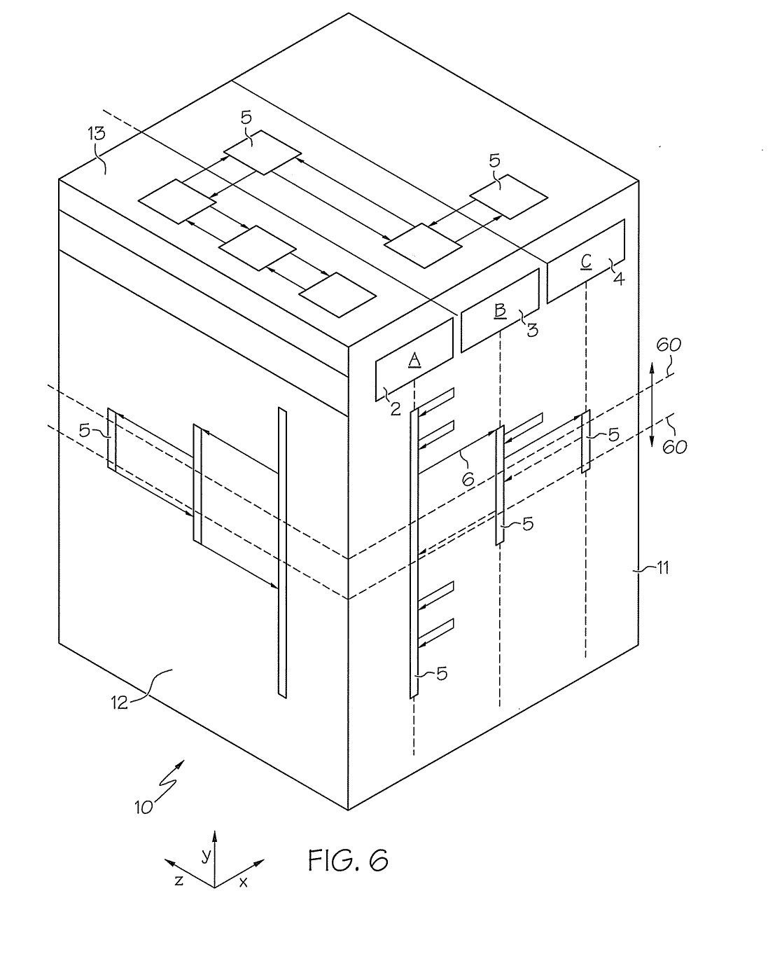

The slicer may include an adjustable height to enable more control of information in the top view, as depicted in FIG. 6.

With regard to the scrolling feature 40 and the slicing feature 50, and other features as one skilled in the art may contemplate (for example, a rotate feature), it may be considered that these features provide for an interactive 3D sequence diagram.

As shown in FIG. 7, a method for providing the 3D sequence diagram 70 calls for reading sequence data 71 and generating the 3D sequence diagram 72. In various embodiments, reading sequence data 71 also includes generating sequence data. In some other embodiments, reading sequence data simply calls for reading a display file that includes objects 2, 3, 4, methods 5 and calls 6. Generating the 3D sequence diagram 72 calls for generating a 3D image using techniques known in the art, and in accordance with the teachings herein.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media and comprising machine readable instructions, for providing a three-dimensional (3D) sequence diagram, the instructions for:
reading sequence data; and
generating the 3D sequence diagram, the diagram depicting objects, methods and calls relating the objects and the methods.

2. The computer program product as in claim 1, wherein the 3D sequence diagram comprises a side view.

3. The computer program product as in claim 2, wherein the side view depicts objects, methods and calls relating the objects and the methods that are hidden in a front view of the 3D sequence diagram.

4. The computer program product as in claim 1, wherein the 3D sequence diagram comprises a top view.

5. The computer program product as in claim 4, wherein the top view depicts objects, methods and calls relating the objects and the methods that are hidden in a front view of the 3D sequence diagram.

6. The computer program product as in claim 1, further comprising a scrolling feature for moving a focus of a side view.

7. The computer program product as in claim 6, wherein moving the focus comprises bringing another object to a side position to view information previously hidden.

8. The computer program product as in claim 1, further comprising a slicing feature for moving a focus of a top view.

9. The computer program product as in claim 8, wherein moving the focus comprises bringing another cross-section of objects and methods to a top position to view information previously hidden.

10. The computer program product as in claim 8, wherein the slicing feature comprises an adjustable height.

11. A computer program product stored on machine readable media and comprising machine readable instructions, for providing an interactive three-dimensional (3D) sequence diagram, the instructions for:
reading sequence data; and
generating the 3D sequence diagram comprising a side view and a top view, the diagram depicting objects, methods and calls relating the objects and the methods;
wherein the side view and the top view depict objects, methods and calls relating the objects and the methods that are hidden in a front view of the 3D sequence diagram;
the 3D sequence diagram further comprising a scrolling feature for moving a side focus of the side view and a slicing feature for moving a top focus of the top view; wherein the slicing feature comprises an adjustable height.
